(19) United States
(12) Patent Application Publication
(10) Pub. No.: US 2006/0080846 A1
(43) Pub. Date: Apr. 20, 2006

(54) Sharpener with integrated pencil cap

(75) Inventor: Fritz Luttgens, Erlangen (DE)

Correspondence Address: LERNER GREENBERG STEMER LLP, P O BOX 2480, HOLLYWOOD, FL, 33022-2480, US

(73) Assignee: KUM Limited

(21) Appl. No.: 11/252,340

(22) Filed: Oct. 17, 2005

(30) Foreign Application Priority Data
Oct. 16, 2004 (DE) 04 024 723.1

(51) Int. Cl. B43L 23/00

(52) U.S. Cl. 30/451

(57) ABSTRACT

A sharpener, which is easy to handle and manufacture, has an integrated pencil cap for sharpening and storing a cosmetic pencil. A sharpener housing accommodates a paring device for the pencil and has an insertion opening for the pencil disposed substantially concentrically with a pencil guide axis of the paring device. The sharpener further includes a pencil cap to be put onto the pencil and has an open end and a closed end lying opposite along a cap axis. The sharpener housing is connected to the pencil cap in an articulated manner such that the pencil cap can be pivoted relative to the sharpener housing into a closed position, in which the pencil cap closes the insertion opening of the sharpener housing, and also into an open position, in which the insertion opening of the sharpener housing is freed for insertion of the pencil.

### BACKGROUND OF THE INVENTION

### Field of the Invention

The invention relates to a sharpener, intended in particular for sharpening a cosmetic pencil. The sharpener has a sharpener housing which accommodates a paring device for a pencil to be sharpened and has an insertion opening for the pencil disposed substantially concentrically with a pencil guide axis of the paring device. The sharpner further has a pencil cap which is intended to be put onto the pencil and has an open end and a closed end lying opposite along a cap axis.

Conventional cosmetic pencils usually have a pencil lead made from a comparatively soft lead mass which is subject to high wear on account of its consistency. A cosmetic pencil must therefore be resharpened particularly often. Furthermore, the lead mass as a rule contains a comparatively high liquid content, for which reason the pencil tip of a cosmetic pencil rapidly becomes unusable as a result of drying-out if stored open. Owing to these circumstances, a cosmetic pencil in constant use can be used optimally only when a sharpener is available at the same time for resharpening as required. It is moreover advantageous to protect the pencil tip during storage by a slipped-on pencil cap in order to avoid damage or rapid drying-out. In this connection, the pencil cap ensures at the same time that the pencil tip does not on the other hand dirty the surrounding environment. A sharpener with an integrated pencil cap is therefore advantageous in connection with a cosmetic pencil for the reasons stated above in particular.

Such a sharpener is known from German Utility Model DE 20 2004 005 040 U1. The known sharpener contains a sleeve-like sharpener housing with an open insertion end, through which a pencil to be sharpened can be inserted toward a paring device disposed in the sharpener housing. A further sleeve-like housing portion, which serves as a pencil cap for the pencil, is disposed at that end of the sharpener housing facing away from the insertion end. This further housing portion is open toward the side facing away from the sharpener housing, so that the open end is disposed opposite the insertion end of the sharpener housing.

A holding device for a sharpener is furthermore known from published, European patent applicatin EP 1 120 285 A1. The holding device is configured as a molded body made from an elastomeric material which can be put onto a pencil in a releasably adhering way from one pencil end in the manner of a cap surrounding the pencil shaft. The holding device also bears a holding projection which is configured for releasably adhering engagement in the pencil guide channel of a sharpener.

A pencil cap for a pencil, into the lateral cap wall of which a paring device is integrated, so that the pencil cap at the same time constitutes a sharpener for the pencil, is also known from U.S. Pat. No. 6,568,090 B2.

### SUMMARY OF THE INVENTION

It is accordingly an object of the invention to provide a sharpener with an integrated pencil cap which overcomes the above-mentioned disadvantages of the prior art devices of this general type, which is easy to produce and handle.

With the foregoing and other objects in view there is provided, in accordance with the invention, a sharpener. The sharpener contains a sharpener housing having an insertion opening, and a paring device for sharpening a pencil and disposed in the sharpener housing. The paring device has a pencil guide axis disposed substantially concentrically with the inerstion opening of the sharpener housing. A pencil cap for receiving the pencil, is provided. The pencil cap has a cap axis, an open end, and a closed end lying opposite the open end along the cap axis. The sharpener housing is connected to the pencil cap in an articulated manner such that the pencil cap can be pivoted relative to the sharpener housing into a closed position in which the pencil cap closes the insertion opening of the sharpener housing, and also into an open position in which the insertion opening of the sharpener housing is freed for insertion of the pencil.

Accordingly, the sharpener contains a sharpener housing with a paring device accommodated therein. The sharpener housing has an insertion opening disposed substantially concentrically with a pencil guide axis of the paring device for insertion of a pencil to be sharpened. The sharpener furthermore includes a protective cap for putting onto the pencil. The pencil cap has an open end and a closed end lying opposite along a cap axis.

According to the invention, the sharpener housing is in this respect connected to the pencil cap in an articulated manner, so that the pencil cap is pivotable relative to the sharpener housing reversibly into a closed position and an open position. The closed position is distinguished by the fact that the pencil cap closes the insertion opening of the sharpener housing. The open position is distinguished by the fact that the insertion opening of the sharpener housing is freed by the pencil cap.

A number of handling advantages are achieved at the same time by the sharpener according to the invention. For one thing, the actual paring device of the sharpener and the pencil cap are secured captively on one another by the articulated connection. This ensures that, during storage of a cosmetic pencil protected with the pencil cap or when it is carried along in a bag or the like, the actual sharpener is always available but on the other hand, during the sharpening operation, the pencil cap cannot be lost and does not expressly have to be held or set down either. Furthermore, in the closed position, the sharpener housing is closed off by the pencil cap, so that no shaving waste can fall out of the sharpener housing during storage or if appropriate during transport of the sharpener. Lastly, the sharpener is easy to handle, in particular easy to adjust between the open position and the closed position, owing to the articulated connection between the sharpener housing and the pencil cap. The sharpener according to the invention is moreover comparatively easy to manufacture as well.

In a particularly space-saving embodiment, the sharpener is configured in such a way that the cap axis when in the closed position is oriented substantially collinearly, that is in alignment, with the pencil guide axis, so that the open end of the pencil cap faces away from the sharpener housing and the closed end of the pencil cap is directly adjacent to the insertion end of the sharpener housing. Advantageously, the sharpener housing and the pencil cap have substantially the same cross-sectional shape in projection along the pencil guide axis or the cap axis, so that the sharpener has an substantially homogeneous rod-like shape in the closed position. By virtue of this, the sharpener is with regard to its shape adapted to the pencil to be received and can thus be stored in a particularly space-saving way with the pencil. The sharpener housing and the pencil cap preferably have a round or polygonal cross-sectional shape.

The pivoting axis of the articulated connection constructed between the sharpener housing and the pencil cap is preferably oriented tangentially relative to the pencil guide axis and the cap axis. Therefore, the pivoting axis extends at right angles relative to the pencil guide axis and cap axis and at a distance from these. In particular, in this connection, the pivoting axis touches the periphery of the sharpener housing and of the pencil cap. Alternatively, the pivoting axis can also be oriented radially or parallel relative to the pencil guide axis and the cap axis.

In an embodiment of the sharpener which is particularly simple to produce, the articulated connection between the sharpener housing and the pencil cap is configured as a film hinge. In this embodiment, the sharpener housing and the pencil cap advantageously constitute components of a comparatively cost-effectively manufacturable one-piece injection-molded part, in particular made of plastic.

In order to avoid the sharpener coming open accidentally, for example when stored in a bag, that is the sharpener housing and the pencil cap being unintentionally pivoted out of the closed position, the sharpener advantageously contains at least one closing element which holds the sharpener housing and pencil cap together releasably in the closed position. The or each such closing element is preferably formed by a projection which is formed on the pencil cap in such a way that it engages in the insertion opening of the sharpener housing in the closed position. In this regard, the releasable connection between the sharpener housing and the pencil cap is advantageously brought about by a frictional connection by the or each closing element, in the closed position, acting radially on the sharpener housing or the paring device disposed therein. Alternatively, the closing element is configured to bring about a catch connection, screwed connection or the like between the sharpener housing and the pencil cap.

The paring device accommodated in the sharpener housing preferably contains a sharpener body on which a paring blade is held set at an angle relative to the pencil guide axis. In order, in particular in the case of a sharpener housing which is closed in the manner of a shaving-collecting housing, to make simple removal of shaving waste possible, the sharpener body is preferably inserted removably into the sharpener housing. In an embodiment which is advantageous as far as both easy handling and to maufacture are concerned, the sharpener body can in this connection be removed from the sharpener housing and put back into it through the insertion opening. In order on the one hand to make it easier to pull the sharpener body out of the sharpener housing and on the other hand to achieve stable guidance of the sharpener body in the sharpener housing, at least one projection which protrudes outward approximately radially relative to the pencil guide axis is advantageously provided at an insertion end of the sharpener body. In this connection, the sharpener housing has in the region of the insertion opening an substantially complementarily shaped indentation for the or each projection. When the sharpener body has been inserted, the or each projection lies substantially with an exact fit in the corresponding indentation of the sharpener housing. The or each projection preferably projects slightly beyond the outer wall of the sharpener housing and consequently forms a grip for pulling the sharpener body out.

An embodiment of the paring device which is particularly stable with a comparatively small outer periphery is produced by the paring blade being provided with a blade width which tapers toward the insertion side of the paring device. This configuration of the paring blade is regarded as inventive in itself. The tapering blade width is preferably produced by an outer edge of the paring blade lying opposite the cutting edge of the paring blade being rounded or sloped at least in a region facing the insertion side. In order to guarantee stable holding of the paring blade and to reduce the space requirement of the paring device further, a blade holder adapted to the blade shape, in particular shaped complementarily to the paring blade, is advantageously configured on the sharpener body.

In an advantageous development of the sharpener, it is additionally provided with a functional element which is intended for applying, distributing and/or removing the lead mass of the pencil or comparable material. The functional element is configured in particular as an eraser, sponge applicator or brush and is in an advantageous embodiment of the sharpener attached to a free end of the sharpener housing opposite the insertion opening. To this end, a holding collar, in which the functional element is inserted for its holding, is preferably formed on the free end of the sharpener housing. In this connection, the functional element is alternatively attached to the sharpener housing by a press fit, gluing or in another way. A protective cap which can optionally be put onto the free end advantageously protects the functional element from damage during storage and transport of the sharpener. In a variant of the sharpener, the functional element is disposed on the closed end of the pencil cap, in particular the closing element provided there advantageously serving at the same time for attaching the functional element. In particular, the functional element is inserted into the closing element, so that the latter again surrounds and retains the functional element in the manner of a holding collar. The two arrangement variants described above of the functional element on the sharpener housing or the pencil cap are optionally also combined with one another by a first functional element being disposed on the free end of the sharpener housing and a second functional element being arranged on the closed end of the protective cap. For example, the first functional element is a brush or an application sponge, whereas the second functional element is configured as an eraser.

Other features which are considered as characteristic for the invention are set forth in the appended claims.

Although the invention is illustrated and described herein as embodied in a sharpener with integrated pencil cap, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, perspective view at an angle from above of a sharpener, in a closed position, with a sharpener housing accommodating a paring device and with a pencil cap connected to the housing in an articulated manner according to the invention;

FIG. 2 is a side view of the sharpener according to FIG. 1 in a half-open position;

FIG. 3 is a perspective view at an angle from above of the sharpener according to FIG. 1 in an open position;

FIG. 4 is a perspective view at an angle from below of the sharpener according to FIG. 1 in the open position;

FIG. 5 is a longitudinal, sectional view of the sharpener housing and the pencil cap taken along the section line V-V shown in FIG. 1;

FIG. 6 is a longitudinal, sectional view of the sharpener housing and the pencil cap taken along the section line VI-VI shown in FIG. 1;

FIG. 7 is a top view of an upper side of the paring device of the sharpener shown in FIG. 1;

FIG. 8 is a side view of the paring device shown in FIG. 7;

FIG. 9 is a top view of a lower side of the paring device shown in to FIG. 7;

FIG. 10 is a sectional view according to FIG. 6 of an alternative embodiment of the sharpener with a functional element disposed on a free end of the sharpener housing;

FIG. 11 is a sectional view according to FIG. 6 of a further embodiment of the sharpener, in which a protective cap is additionally put detachably onto the free end of the sharpener housing bearing the functional element; and

FIG. 12 is a sectional view according to FIG. 6 of a further embodiment of the sharpener, in which a functional element is disposed on the closed end of the pencil cap.

### DESCRIPTION OF THE PREFERRED EMBODIMENTS

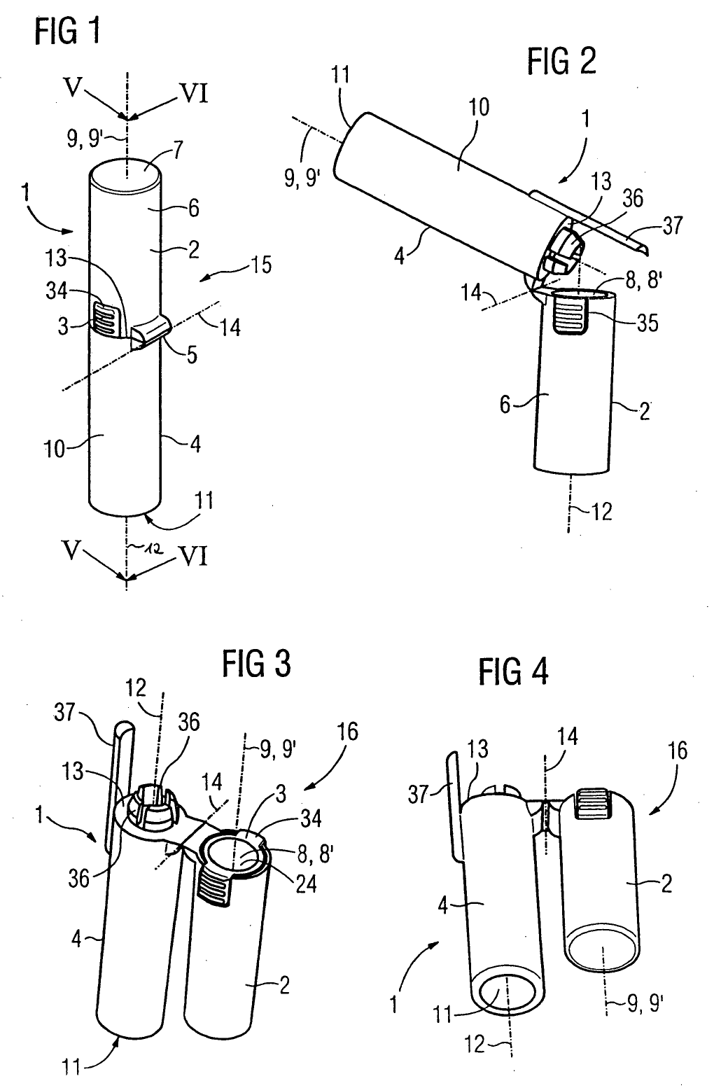

In all the figures of the drawing, sub-features and integral parts that correspond to one another bear the same reference symbol in each case. Referring now to the figures of the drawing in detail and first, particularly, to FIG. 1 thereof, there is shown a sharpener 1. The sharpener 1 contains a sharpener housing 2 with a paring device 3 accommodated therein for sharpening a non-illustrated cosmetic pencil.

The sharpener 1 also contains a pencil cap 4 to be put on the cosmetic pencil, in particular onto a pencil tip. The sharpener housing 2 and the pencil cap 4 are interconnected in an articulated manner via a film hinge 5. The sharpener housing 2 and the pencil cap 4 consequently form a one-piece component, which is manufactured in particular as an injection-molded plastic part.

The sharpener housing 2 has a substantially cup shape with a cylindrical housing wall 6 which is closed off at one longitudinal end by a housing end wall 7 forming a cup bottom. The longitudinal end of the sharpener housing 2 opposite the housing end wall 7 is open and serves as an insertion opening 8 (see FIGS. 2 and 3) for the cosmetic pencil to be sharpened. A housing longitudinal axis 9, which coincides with a pencil guide axis 9′ of the paring device 3, is defined by the axis of symmetry of the cylindrical housing wall 6.

The pencil cap 4 is likewise of a substantially cup-like configuration and contains a cylindrical cap wall 10 with an open end 11 (FIG. 4 in particular) and a closed end 13 opposite the latter in a direction of a cap axis 12 (FIG. 3 in particular).

The film hinge 5 connects that end side of the sharpener housing 2 bearing the insertion opening 8 to the closed end 13 of the pencil cap 4 in such a way that the sharpener housing 2 and the pencil cap 4 are pivotable in relation to one another about a pivoting axis 14 oriented substantially tangentially relative to the sharpener housing 2 and the pencil cap 4. The pivoting axis 14 consequently always extends at right angles to and at a distance from both the housing longitudinal axis 9 (and the pencil guide axis 9′ coinciding with it) and the cap axis 12—irrespective of the pivoting position of the sharpener housing 2 relative to the pencil cap 4.

A first pivoting position of the sharpener housing 2 relative to the pencil cap 4, designated below as the closed position 15, is illustrated in FIG. 1. In this position, the closed end 13 of the pencil cap 4 is directly adjacent to the end side of the sharpener housing 2 bearing the insertion opening 8, so that the insertion opening 8 is closed by the pencil cap 4. In this connection, the pencil guide axis 9′ and the cap axis 12 are disposed in alignment with one another. The sharpener housing 2 and the pencil cap 4 have substantially the same diameter, so that the cap wall 10 is also disposed in alignment with the housing wall 6. In the closed position 15, the sharpener 1 consequently has substantially the shape of a simple cylindrical rod. In this connection, the open end 11 of the pencil cap 4 is disposed at a free end of this rod shape, so that the sharpener 1 can in the closed position 15 be put onto a cosmetic pencil.

During storage and if appropriate during transport, the sharpener 1 is intended to be in the closed position 15, so that under these circumstances on the one hand the sharpener housing 2 with any shaving waste contained in it is safely closed but on the other hand the open end 11 of the pencil cap 4 is accessible.

To sharpen a cosmetic pencil, the sharpener 1 is intended to be pivoted via the half-open pivoting position illustrated in FIG. 2 into an open position 16 illustrated in FIGS. 3 and 4, in which the sharpener housing 2 and the pencil cap 4 are disposed at an angle to one another or even approximately parallel to one another. In the open position 16, the insertion opening 8 of the sharpener housing 2 is freed by the pencil cap 4, so that the cosmetic pencil to be sharpened can be inserted through the insertion opening 8 into the sharpener housing 2 along the pencil guide axis 9′.

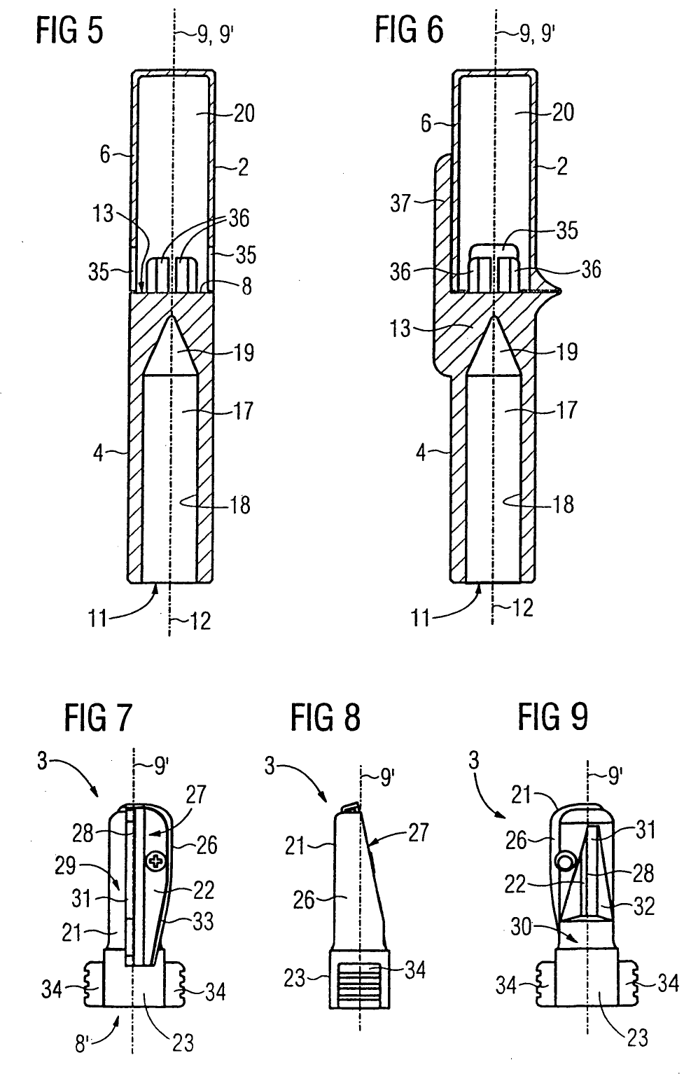

The sharpener housing 2 and the pencil cap 4 of the sharpener 1 are illustrated in two longitudinal sections at right angles to one another in FIGS. 5 and 6. In this illustration, it is clear in particular that the pencil cap 4 has a cap interior 17 for partially receiving the cosmetic pencil. The diameter of the cap interior 17 is in this connection adapted in such a way to the cosmetic pencil to be received that the latter can be pushed into or removed from the pencil cap 4 only using a predetermined force. This serves on the one hand for retaining the pencil cap 4 on the cosmetic pencil to be protected. On the other hand, the pencil cap 4 is preferably configured in such a way that the inner wall 18 delimiting the cap interior 17 surrounds the periphery of the inserted cosmetic pencil on all sides under prestress, so that the pencil tip to be protected is sealed in relation to the outside world. The cap interior 17 is optionally of conical design, in conformity with the pencil tip of the cosmetic pencil to be received, in a region 19 adjoining the closed end 13, so that the pencil cap 4 surrounds the pencil tip of the inserted cosmetic pencil closely. In this way, on the one hand particularly good mechanical protection for the delicate pencil tip is achieved, and on the other hand drying-out of the pencil tip is counteracted particularly effectively.

As can be seen from FIGS. 5 and 6, the sharpener housing 2 has a housing interior 20. The housing interior 20 is open toward the insertion opening 8 and serves for accommodating the paring device 3 illustrated in greater detail in FIGS. 7 to 9.

The paring device 3, which constitutes the actual sharpening unit of the sharpener 1, contains a sharpener body 21, on which a paring blade 22 is attached. The sharpener body 21 contains a pencil guide sleeve 23, a bore 24 (FIG. 3) of which defines a pencil guide channel which is filled during the sharpening operation by the cosmetic pencil to be sharpened and is centered relative to the pencil guide axis 9′.

The pencil guide sleeve 23 is adjoined in the axial direction by a blade holder 26. The blade holder 26 is of wedge-like configuration (FIG. 8 in particular), a support surface 27 for the paring blade 22 being configured along the wedge slope. The paring blade 22 is held on the support surface 27 in such a way that a cutting edge 28 of the paring blade 22 cuts approximately at a predetermined angle.

That side of the paring device 3 facing the support surface 27 and the paring blade 22 is designated as the upper side 29. The opposite side of the paring device 3 is correspondingly described as the lower side 30. As can be seen from FIG. 7 in particular, a cutting slot 31, which makes shaving ejection possible during the sharpening operation, is formed between the cutting edge 28 and the adjacent region of the blade holder 26. An approximately trapezoidal opening 32, which in particular makes the ejection of the soft lead mass of the cosmetic pencil pared off during the sharpening operation easier, is provided on the lower side 30 in a region of the blade holder 26 lying opposite the paring blade 22. The pencil guide channel extended into the region of the blade holder 26 is consequently open toward the upper side 29 through the cutting slot 31 and toward the lower side 30 through the opening 32.

The paring blade 22 is preferably configured in such a way that the blade width tapers in the direction of the pencil guide sleeve 23. The blade shape, which is advantageous with regard to great stability with at the same time a particularly small space requirement, is brought about in particular by an outer edge 33 of the paring blade 22 lying opposite the cutting edge 28 being sloped in a region which faces the pencil guide sleeve 23 in the fitted position. On the other hand, that region of the outer edge 33 facing away from the pencil guide sleeve 23 in the fitted position is preferably rounded as in the case of conventional sharpener blades. The support surface 27 is adapted to the shape of the paring blade 22 in order to guarantee accurate and stable bearing of the paring blade 22.

Two projections 34 diametrally opposite one another, which serve as grips for inserting the paring device 3 into the sharpener housing 2 or pulling the paring device 3 out of the sharpener housing 2, are formed on the outer periphery of the pencil guide sleeve 23. The paring device 3 is inserted through the insertion opening 8 into the housing interior 20 of the sharpener housing 2 with the blade holder 26 first. In the inserted state, the pencil guide sleeve 23 ends approximately level with the insertion opening 8, so that the insertion opening 8 of the sharpener housing 2 coincides with an insertion opening 8′ of the bore 24. In this connection, each projection 34 lies in a corresponding indentation 35 (FIGS. 2, 5 and 6) fashioned in the housing wall 6 in a region adjacent to the insertion opening 8. The projections 34 preferably project slightly beyond the outer periphery of the sharpener housing 2, so that they can be gripped easily for pulling the paring device 3 out. Removal of the paring device 3 from the sharpener housing 2 is intended in particular for disposal of shaving waste and lead residues from the sharpener housing 2.

Four closing elements 36, which fix the sharpener 1 releasably in the closed position, so that accidental opening of the sharpener 1 is avoided, are provided on the closed end 13 of the pencil cap 4. Each closing element 36 forms a projection of approximately circular-segment-shaped cross section which protrudes from the closed end 13 in the direction of the cap axis 12. The four closing elements 36 consequently together form approximately a ring slotted crosswise. In this connection, the closing elements 36 are positioned in such a way that they can be inserted into the bore 24 of the pencil guide sleeve 23 under a predetermined closing pressure during closing of the sharpener 1. In the closed position, the closing elements 36 consequently engage in the insertion opening 8 of the sharpener housing 2, acting radially on the pencil guide sleeve 23 of the paring device 3 and consequently opposing opening of the sharpener 1 with a holding force. The closing elements 36 are beveled or rounded on their outer edge in order to avoid jamming of the closing elements 36 with the guide sleeve 23.

Furthermore, the sharpener 1 optionally contains a cleaning rod 37. The cleaning rod is preferably formed in one piece on the pencil cap 4 in such a way that it projects beyond the closed end 13 and consequently protrudes freely in the open position 16 of the pencil cap 4 relative to the sharpener housing 2 while it lies against the outer periphery of the sharpener housing 2 in the closed position 15. The cleaning rod 37 can alternatively be formed on the sharpener housing 2 or be attached insertably to the pencil cap 4 or the sharpener housing 2. The sharpener 1 also optionally contains a non-illustrated lead shaper, as is usually present in cosmetic sharpeners, for rounding the pencil tip during the sharpening operation.

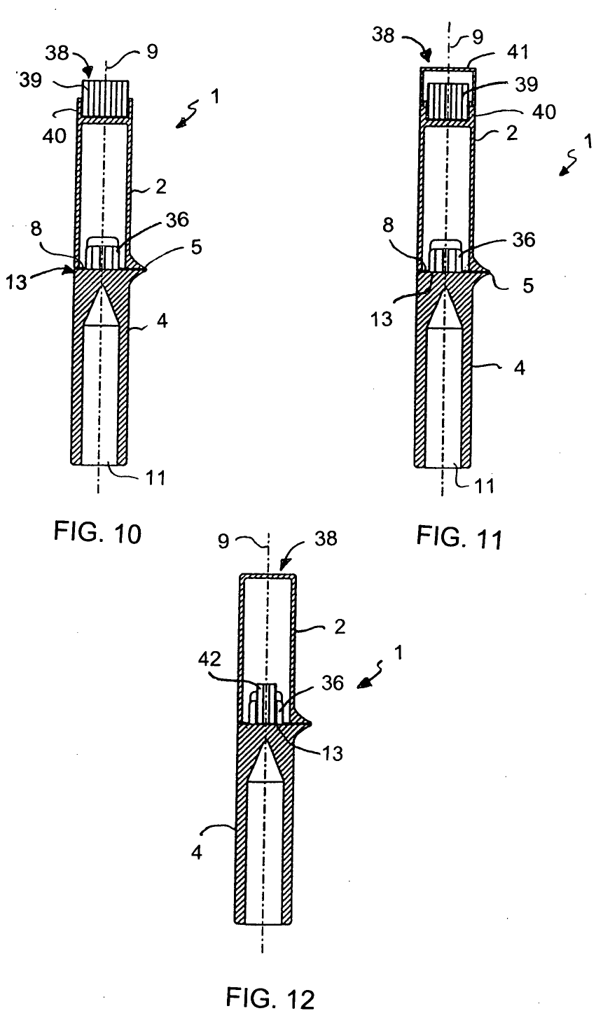

FIGS. 10 and 11 show further embodiments of the sharpener 1 where a functional element 39 in the form of an eraser, sponge or brush is provided at a free end 38 of the sharpener housing 2 opposite the insertion opening 8. In this connection, the functional element 39 is intended for applying or distributing lead mass of the pencil or comparable material on a surface or removing it from the surface. For holding the functional element 39 on the sharpener housing 2, a holding collar 40 is formed on the free end 38 of the latter, which collar protrudes in the direction of the housing longitudinal axis 9 and into which the functional element 39 is inserted. The functional element 39 is alternatively held in the holding collar 40 simply by a press fit or glued on or otherwise secured against loss. In the embodiment according to FIG. 11, a protective cap 41, which in this position surrounds the functional element 39 and consequently protects it from damage, dirtying or the like, is put onto the holding collar 40. For use of the functional element 39, the protective cap 41 is reversibly detachable. Alternatively, the protective cap 41 is also attached captively and in an articulated manner to the sharpener housing 2, in particular by a film hinge (not illustrated further), and can be pivoted away out of the closed position shown in FIG. 11 to free the functional element 39.

In a further embodiment of the sharpener 1 shown in FIG. 12, a functional element 42, which again is configured alternatively as an eraser, brush or sponge, is disposed on the closed end 13 of the pencil cap 4. In particular the closing elements 36, which again form a kind of holding collar into which the functional element 42 is inserted and are present anyway on the closed end 13, serve for holding the functional element 42. Optionally, both functional elements 39 and 42 are provided on the sharpener 1 at the same time. In this connection, the functional elements 39 and 42 are in particular different. For example, the functional element 39 is configured as a sponge or a brush, and the functional element 42 is configured as an eraser, or vice versa.

This application claims the priority, under 35 U.S.C. §119, of European patent application No. 04 024 723.1, filed Oct. 16, 2004; the entire disclosure of the prior applications are herewith incorporated by reference.

I claim:

1. A sharpener, comprising:
a sharpener housing having an insertion opening formed therein;
a paring device for sharpening a pencil and disposed in said sharpener housing, said paring device having a pencil guide axis disposed substantially concentrically with said inerstion opening of said sharpener housing; and
a pencil cap for receiving the pencil, said pencil cap having a cap axis, an open end formed therein and a closed end lying opposite said open end along said cap axis, said sharpener housing connected to said pencil cap in an articulated manner such that said pencil cap can be pivoted relative to said sharpener housing into a closed position in which said pencil cap closes said insertion opening of said sharpener housing, and also into an open position in which said insertion opening of said sharpener housing being freed for insertion of the pencil.

2. The sharpener according to claim 1, wherein when in the closed position, said cap axis is disposed substantially collinearly with said pencil guide axis, and said open end of said pencil cap faces away from said sharpener housing.

3. The sharpener according to claim 1, wherein said sharpener housing and said pencil cap have substantially a same cross-sectional shape in projection along said pencil guide axis or said cap axis.

4. The sharpener according to claim 1, wherein said sharpener housing and said pencil cap are pivotable in relation to one another about a pivoting axis oriented tangentially relative to said pencil guide axis and said cap axis.

5. The sharpener according to claim 1, further comprising a film hinge and said sharpener housing and said pencil cap are interconnected in an articulated manner by said film hinge.

6. The sharpener according to claim 1, further comprising at least one closing element fixing said sharpener housing and said pencil cap releasably to one another in the closed position.

7. The sharpener according to claim 6, wherein said at least one closing element is formed by a projection formed on said closed end of said pencil cap and said projection engages in said insertion opening of said sharpener housing in the closed position forming a frictional connection acting radially relative to said pencil guide axis.

8. The sharpener according to claim 1, wherein said paring device includes:
a paring blade; and
a sharpener body inserted removably into said sharpener housing, said sharpener body holding said paring blade in a position set at an angle relative to said pencil guide axis.

9. The sharpener according to claim 8, wherein said sharpener body can be removed from said sharpener housing through said insertion opening.

10. The sharpener according to claim 9, wherein:
said sharpener body has at least one projection protruding outward approximately radially relative to said pencil guide axis; and
said sharpener housing has a substantially complementarily shaped indentation formed therein and said at least one projection lies in said substantially complementarily shaped indentation.

11. The sharpener according to claim 8, wherein:
said sharpener body has a pencil guide sleeve; and
said paring blade has a blade width which tapers in a direction of said pencil guide sleeve.

12. The sharpener according to claim 1, further comprising a functional element for applying, distributing and/or removing lead mass of the pencil, said functional element is disposed on a free end of said sharpener housing facing away from said insertion opening.

13. The sharpener according to claim 12, wherein said sharpener housing has a holding collar, into which said functional element is inserted, said holding collar formed on said free end for holding said functional element.

14. The sharpener according to claim 12, further comprising a protective cap for protecting said functional element, said protective cap detachably disposed on said free end.

15. The sharpener according to claim 1, further comprising a functional element for applying, distributing and/or removing lead mass of the pencil and disposed on said closed end of said pencil cap.

16. The sharpener according to claim 12, wherein said functional element is selected from the group consisting of an eraser, a sponge and a brush.

17. The sharpener according to claim 15, wherein said functional element is selected from the group consisting of an eraser, a sponge and a brush.
